(19) United States
(12) Patent Application Publication
(10) Pub. No.: US 2012/0189315 A1
(43) Pub. Date: Jul. 26, 2012

(54) OPTICAL TRANSMISSION SYSTEM AND APPARATUS

(75) Inventor: Mariko SUGAWARA, Kawasaki (JP)

(73) Assignee: FUJITSU LIMITED, Kawasaki (JP)

(21) Appl. No.: 13/305,167

(22) Filed: Nov. 28, 2011

(30) Foreign Application Priority Data
Jan. 24, 2011 (JP) 2011-011515

(51) Int. Cl. H04B 10/02

(52) U.S. Cl. 398/135; 398/140

(57) ABSTRACT

There is provided an optical transmission system including a first optical transmission apparatus configured to have a first transmission mode in which a first signal is transmitted at a first optical level, and a second transmission mode in which a second signal is transmitted at a second optical level after an operation in the first transmission mode, the first optical level being lower than the second optical level, and a second optical transmission apparatus configured to have a third transmission mode in which a response signal to the first signal is transmitted at the first optical level to the first optical transmission apparatus, and a fourth transmission mode in which a response signal to the second signal is transmitted at the second optical level to the first optical transmission apparatus after an operation in the third transmission mode.

### CROSS-REFERENCE TO RELATED APPLICATION

This application is based upon and claims the benefit of priority of the prior Japanese Patent Application No. 2011-011515, filed on Jan. 24, 2011, the entire contents of which are incorporated herein by reference.

### FIELD

The embodiments discussed herein are related to an optical transmission system and an optical transmission apparatus.

### BACKGROUND

With the increase of network traffic, the improvements for high-speed electrical transmission are approaching the limit. For future increase in capacity of transmission in the future, an optical interconnect technology which applies light for transmission medium and close range transmissions has attracted attention.

The optical interconnect technology may be effective for transmission by light in which close-range data transmission is performed between circuits within a semiconductor chip, parts within a device, or substrates within an apparatus, for example. The optical interconnect technology may implement high-speed and wide-band transmission, compared with an electrical transmission technology by copper wiring in the past.

In recent years, also in a blade server used for a large-scale system, the replacement of electrical signals by optical signals in transmissions between many blades has been studied. A blade server is a server system storing in a chassis called an enclosure a plurality of blades which are server substrates on which elements for implementing computing functions of a processor, a memory and so on are mounted. Many servers (blade servers) may be provided therein, and the reliability of the entire system may be improved.

A related art proposed in the past is an apparatus which performs optical transmission by optical interconnect. Optical module for user eye safety has been further proposed. Reference may be made to Japanese Laid-open Patent Publication No. 2008-26483.

When optical transmission by optical interconnect is applied within a blade server or a blade server system, many optical signals (such as several tens channels) are transmitted. In an optical connection part (optical port) where optical signals concentrate, a high-power optical signal may be externally exposed, which may harm the human body.

In other words, when blades are not inserted to a midplane (which is a backplane having connectors on both sides thereof to which substrates of blade servers may be inserted), or when an optical connector is not normally connected, an optical signal beyond an eye-safety reference value (which is a reference value of optical power that does not damage the human eyes) may be externally exposed, which may pose risk to the human eyes.

The use of a mechanism such as a shutter may prevent the problem, but it may increase the size of the system and the cost. A blade server and/or a blade server system have been demanded which uses simple measures that are compliant with the high-precision eye-safety reference.

### SUMMARY

According to an aspect of the embodiment, there is provided an optical transmission system including a first optical transmission apparatus configured to have a first transmission mode in which a first signal is transmitted at a first optical level, and a second transmission mode in which a second signal is transmitted at a second optical level after an operation in the first transmission mode, the first optical level being lower than the second optical level, and a second optical transmission apparatus configured to have a third transmission mode in which a response signal to the first signal is transmitted at the first optical level to the first optical transmission apparatus, and a fourth transmission mode in which a response signal to the second signal is transmitted at the second optical level to the first optical transmission apparatus after an operation in the third transmission mode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of an optical transmission system;

FIG. 2 illustrates a configuration example of a blade server;

FIG. 3 illustrates a management table;

FIG. 4 illustrates a management table;

FIG. 5 illustrates a configuration example of a blade server;

FIG. 6 is a flowchart illustrating an operation by a blade server;

FIG. 7 is a flowchart illustrating an operation by a blade server;

FIG. 8 is a flowchart illustrating an operation by a blade server;

FIGS. 9A and 9B are flowcharts illustrating operations by a blade server;

FIG. 10 illustrates a management table;

FIG. 11 illustrates a management table;

FIG. 12 illustrates a configuration example of a blade server;

FIG. 13 illustrates an example of the management table provided in the controlling device;

FIG. 14 is a flowchart illustrating an operation for identifying the mounting state of the other transmission party;

FIG. 15 illustrates a management table;

FIG. 16 illustrates a configuration example of a blade server;

FIG. 17 is a flowchart illustrating an operation for identifying the mounting state of the other transmission party;

FIG. 18 illustrates a configuration example of a band variable optical receiver; and

FIG. 19 illustrates a configuration example of a band variable optical receiver.

### DESCRIPTION OF EMBODIMENTS

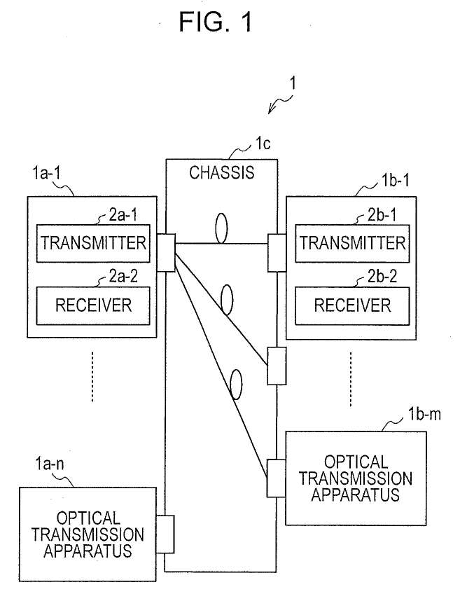

Hereinafter, embodiments will be described with reference to drawings. FIG. 1 illustrates a configuration example of an optical transmission system. An optical transmission system 1 includes optical transmission apparatuses 1a-1 to 1a-n, optical transmission apparatuses 1b-1 to 1b-m and a chassis called an enclosure 1c. The optical transmission apparatuses 1a-1 to 1a-n and optical transmission apparatuses 1b-1 to 1b-m are mounted in the chassis 1c and are connected with optical fiber through each an optical port.

For simple description, the optical transmission apparatuses 1a-1 to 1a-n are on the transmitter side (source apparatus), and the optical transmission apparatuses 1b-1 to 1b-m are on the receiver side (destination apparatus). In reality, however, one optical transmission apparatus has transmitter and receiver functions.

The optical transmission apparatuses 1a-1 to 1a-n include a transmitter 2a-1 and a receiver 2a-2, and the optical transmission apparatuses 1b-1 to 1b-m include a transmitter 2b-1 and a receiver 2b-2. The transmitter 2a, independent of the mounting of destination apparatuses, transmits a test signal to optical ports of all destination apparatuses in the chassis 1c to which the destination apparatuses is optically connected. The test signal is used for determining the optical connection state of the destination apparatus (whether the destination apparatus has been mounted in the chassis or not or whether a connection defective exists or not).

In this case, an optical level of the test signal to be transmitted is set to a low level which does not harm the human body. Signal having an operational optical level for a normal communication service (communication service signal light) is transmitted to the destination apparatuses having returned response signal which is a response to the test signal to start the communication service.

The receiver 2b is connected to a predetermined optical port in the chassis 1c. If the test signal is received, the response signal is returned to the corresponding optical transmission apparatuses 1a-1 to 1a-n. An optical level of the response signal is also set to a low level which does not harm the human body to prevent damage to the human body. For example, even when the connection part between the receiver 2a-2 in the optical transmission apparatus 1a-1 and the chassis 1c only has a connection defective, the light leaked from the connection defective to the outside if any may not harm the human body. When signal light transmitted from the optical transmission apparatuses 1a-1 to 1a-n is received by the receiver 2b, the receiver 2b executes a communication service together with the optical transmission apparatus which is the other transmission party. (The destination apparatuses may be described as the other transmission party.)

In this way, the optical level of the test signal set to a low level which does not harm the human body is transmitted, and the signal having an operational optical level is transmitted to the other transmission party having returned response signal to start a communication service.

Thus, from the determination of the other transmission party to the start of the communication service, the test signal having a low optical level is used for signal exchange between optical transmission apparatuses. This may prevent damage to the human body even when light leaks from a part where no apparatus is mounted in the chassis 1c or a connection defective to the outside. Highly-precise eye-safety may be implemented without using a mechanism such as a shutter, and the reliability may be improved.

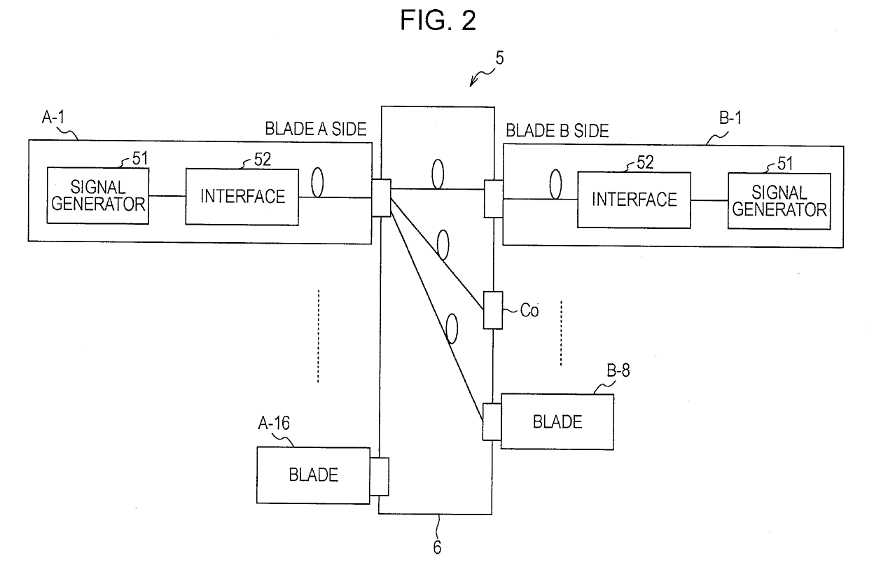

Next, a configuration of a blade server applying optical interconnect will be described. FIG. 2 illustrates a configuration example of a blade server. A blade server 5 includes blades A-1 to A-16, blades B-1 to B-8 and a midplane 6. The blades A-1 to A-16 and blades B-1 to B-8 are mounted on the midplane 6 via an optical connector Co and are connected to optical fiber within the midplane 6 for mutual optical transmission.

The blades A-1 to A-16 will collectively be called a blade A, and the blades B-1 to B-8 will collectively be called a blade B. Each of the blades A and B includes a signal generator 51 and an interface 52. The signal generator 51 generates a transmission signal which is an electrical signal and performs transmission and reception processing. The interface 52 performs E/O conversion which converts an electrical transmission signal to an optical signal or O/E conversion which converts an optical signal to an electrical transmission signal. The signal generator 51 and the interface 52 are electrically connected, and the interface 52 and the optical connector Co are optically connected.

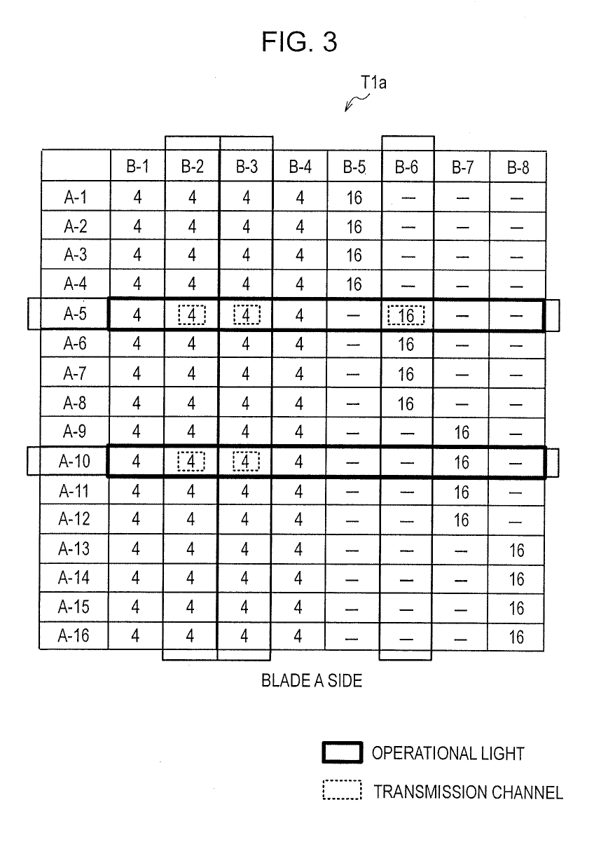

Next, a management table describing a communication relationship between the blade A and the blade B will be described. FIG. 3 illustrates the management table. A management table T1a describes communication states from the viewpoint of the blade A side. The signs referring to blades A-1 to A-16 are given in the vertical direction, and signs referring to the blades B-1 to B-8 are given in the horizontal direction.

The parallel optical transmission is provided between a single blade of the blade A and a single blade of the blade B, for example, parallel optical transmission through four channels or parallel optical transmission through sixteen channels are provided.

For example, the number “4” given at the intersection between A-5 and B-2 in the table refers to parallel optical transmission through four channels between the blade A-5 and the blade B-2. The number “16” given at the intersection between A-5 and B-6 refers to parallel optical transmission through 16 channels between the blade A-5 and the blade B-6.

The symbol “-” (hyphen) in the table refers to the state that the blades do not have a communication relationship at the current stage. For example, the symbol “-” at the intersection between A-5 and B-5 refers to the state that the blade A-5 and blade B-5 do not have a communication relationship at the current stage, and the transmission between the blade A-5 and blade B-5 is not provided.

It is assumed here that the blades A-5 and A-10 on the blade A side are inserted in the midplane 6 and the blades B-2, B-3, and B-6 on the blade B side are inserted in the midplane 6.

The blade server 5 upon initial start causes exchange of an optical signal between the blade A and the blade B to check the other transmission parties. In this case, the blade A-5 communicates with the blades B-2, B-3, and B-6 of the blades B-1 to B-8. However, because the blade A side may not recognize the inserted blades on the blade B side, an optical signal is transmitted to all blades of the blades B-1 to B-8.

Then, the optical signal transmitted from the blade A-5 leaks to the outside from the vacant parts where no blades are inserted on the blade B side (vacant ports of connector in which blade B-1, B-4, B-5, B-7, and B-8 are inserted). The blade A-5 transmits an optical signal at an operational optical level which is beyond the eye-safety reference. For that, the optical signal having the optical level beyond the eye-safety reference is externally exposed, which may pose important risk to the human body.

The same is true in the blade A-10. Because the blade A-10 communicates with the blades B-2 and B-3 of the blades B-1 to B-8, the blade A-10 may actually transmit an optical signal to the blades B-2 and B-3.

However, because the blade A side may not recognize the inserted blades on the blade B side, an optical signal is transmitted to all blades B of the blades B-1 to B-8 after all.

The optical signal having high optical level transmitted from the blade A-10 leaks to the outside from the vacant parts (blades B-1, B-4, B-5, B-6, B-7, B-8) where no blades are inserted on the blade B side.

Blades may be connected to a plurality of blades. As the number of parts to which blades are to be connected increases, the optical level (power) to be exposed increases. For example, currently, the blade A-5 and A-10 are inserted, and the blade B-1 is not inserted.

In this case, both of the optical signal transmitted from the blade A-5 and the optical signal transmitted from the blade A-10 are transmitted to the uninserted blade B-1, which expose the optical signal having significantly high optical level (high optical power) from the part where the blade B-1 is not inserted.

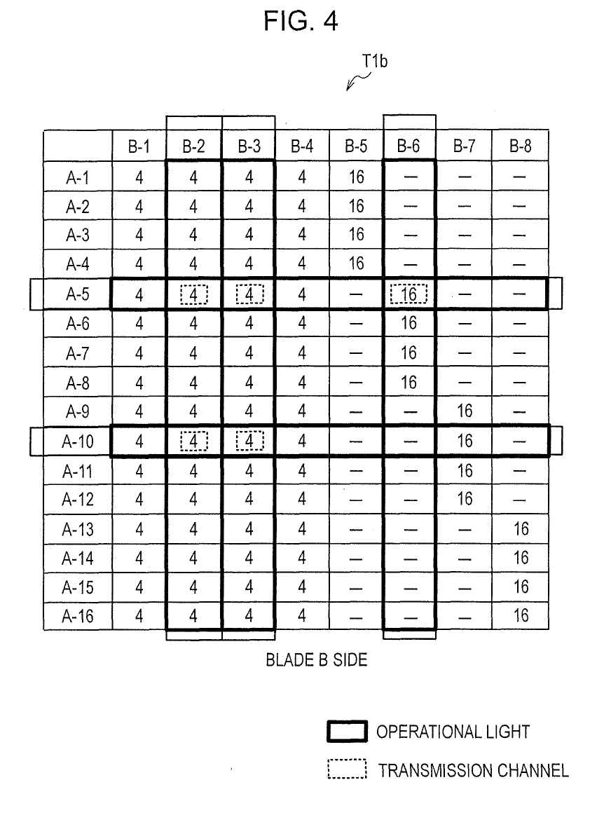

FIG. 4 illustrates a management table. A management table T1b describes communication states from the viewpoint of the blade B side. The blades A-5 and A-10 on the blade A side are inserted in the midplane 6 and the blades B-2, B-3, and B-6 on the blade B side are inserted in the midplane 6, similarly to FIG. 3.

The blade B-2 communicates with the blades A-5 and A-10 of the blades A-1 to A-16. However, because the blade B side may not recognize the inserted blades on the blade A side, an optical signal is transmitted to all blades of the blades A-1 to A-16.

Then, the optical signal transmitted from the blade B-2 leaks to the outside from the vacant parts where no blades are inserted on the blade A side (vacant ports of connector in which blades A-1 to A-4, A-6 to A-9, and A-11 to A-16 are inserted).

The blade B-2 transmits an optical signal at an operational optical level which is beyond the eye-safety reference. For that, the optical signal having optical level (optical power) beyond the eye-safety reference is externally exposed, which may pose important risk to the human body.

Because the same is true regarding the blades B-3 and B-6, the description will be omitted. Blades may be connected to a plurality of blades. As the number of parts to which blades are to be connected increases, the optical level (power) to be exposed increases. For example, currently, the blade B-2, B-3 and B-6 are inserted, and the blade A-6 is not inserted.

In this case, both of the optical signal transmitted from the blades B-2, B-3, and B-6 are transmitted to the uninserted blade A-6, which expose the optical signal having significantly high optical level (power) from the part where the blade A-6 is not inserted.

In this way, in a blade server applying optical interconnect, an optical signal having optical level (power) beyond eye-safety reference may possibly expose from a part where no blade is inserted or a connection defective of an optical connector, which may pose severe risk to the human body.

The present art was made in view of the problems and provides an optical transmission system which implements highly precise eye-safety and improves the reliability.

### First Embodiment

The configuration and operations of the optical transmission system 1 applied to a blade server will be described in detail.

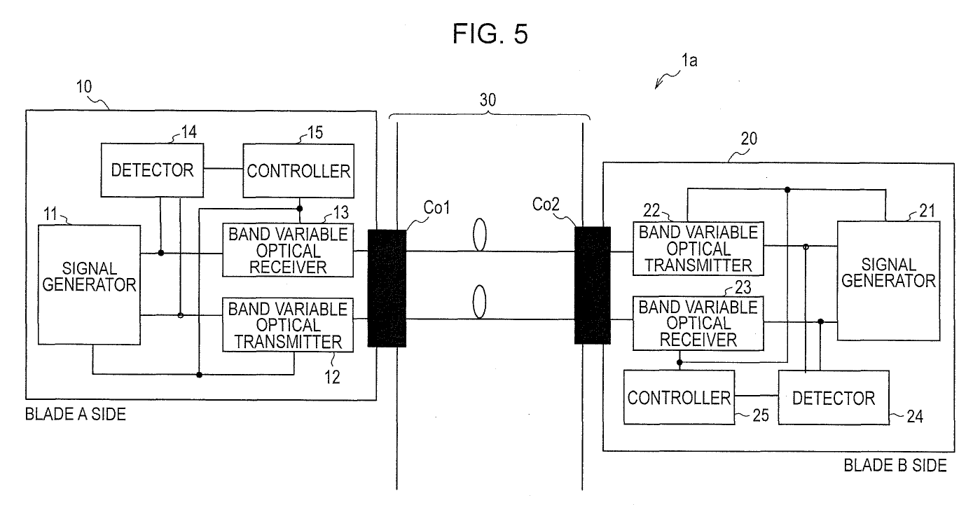

FIG. 5 illustrates a configuration example of a blade server. A blade server is includes a blade 10, a blade 20 and a midplane 30. The blade 10 on the blade A side is mounted in the midplane 30 and the blade 20 on the blade B side is mounted in the midplane 30.

The blade 10 is connected to a predetermined connection part on the midplane 30 through an optical connector Co 1. The blade 20 is connected to a predetermined connection part on the midplane 30 through an optical connector Co 2. The blade 10 and blade 20 performs mutual optical transmission through optical fiber provided by optical interconnect within the midplane 30. Though both of the blades 10 and 20 contain a plurality of blades in reality, one of each is illustrated.

The blade 10 includes a signal generator 11, a band variable optical transmitter 12, a band variable optical receiver 13, a detector 14 and a controller 15. The blade 20 includes a signal generator 21, a band variable optical transmitter 22, a band variable optical receiver 23, a detector 24 and a controller 25.

The signal generator 11 generates control signals before an operation starts and communication service signals during an operation. The band variable optical transmitter 12 performs E/O conversion to convert an electrical signal to an optical signal to be transmitted. In this case, between the initial start and a normal operation, the settings of the transmission band and transmission level are changed.

More specifically, upon initial start as a first transmission mode, the optical transmission band is set to a low-speed band having a lower rate than that for a normal operation, and the transmission level is set to a low optical level at or under an eye-safety reference value. For a normal operation as a second transmission mode, the optical transmission band is changed to an operational band (high-speed band), and the transmission level is set to an operational level with higher light power than the low-light level.

The band variable optical receiver 13 performs O/E conversion to convert a received optical signal to an electrical signal. Between the initial start and a normal operation, the setting of the reception band is changed. More specifically, for the initial start, the optical reception band is changed to a low-speed band having lower rate than that for a normal operation. For a normal operation, the optical reception band is changed to an operational band (high-speed band).

The detector 14 determines whether the signal to be transmitted or the received signal is a predetermined signal or not and transmits the detection result to the controller 15. On the basis of the detection result, the controller 15 controls the signal generation by the signal generator 11 or instructs to change the variable setting of the band in the band variable optical transmitter 12 and band variable optical receiver 13. The components having the same names as those within the blades 10 and 20 have the same operational functions. Therefore, the descriptions on the components in the blade 20 will be omitted.

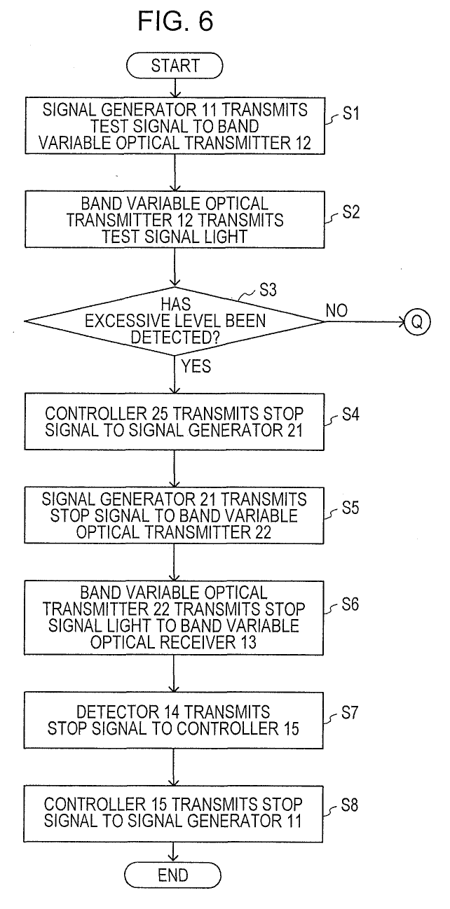

Next, operations will be described with reference to flowcharts. FIG. 6 to FIGS. 9A and 9B are flowcharts illustrating operations by the blade server 1a. It is assumed that the default band for the band variable optical transmitters 12 and 22 and band variable optical receivers 13 and 23 upon initial start is a low-speed band.

[operation S1] Upon initial start, the signal generator 11 generates a test signal and transmits it to the band variable optical transmitter 12. The test signal is a control signal for determining that whether the transmission to the other party (destination apparatus) is possible or not. In other words, the test signal is a signal for determining the optical connection state of the other transmission party.

[operation S2] If the band variable optical transmitter 12 receives the test signal, the band variable optical transmitter 12 performs E/O conversion thereon to generate test signal light and transmits the test signal light to a communicable party (destination apparatus) through the midplane 30. The optical level of the test signal light is lower than the optical level of the communication service signal light to be transmitted during a normal operation. The test signal light is low-power light having an optical level satisfying the eye-safety reference value. Thus, if the test signal light leaks to the outside of the midplane 30, the light does not harm the human body because the optical level thereof is at or under the eye-safety reference value.

[operation S3] If the band variable optical receiver 23 in the blade 20 receives the test signal light, the band variable optical receiver 23 performs O/E conversion to generate an electrical test signal and transmits it to the detector 24. The detector 24 identifies the optical level of the received test signal. The detector 24 may identify an optical level of the test signal light detected by the band variable optical receiver 23, or an optical level according to an electrical level of the test signal light detected by the detector 24.

If the optical level identified by the detector 24 is an excessive level and if it is determined that the light transmitted from the blade A side is beyond the eye-safety reference value, the operation moves to operation S4. If the identified level is a low level and if it is determined that the light transmitted from the blade A side is not beyond the eye-safety reference value, the operation moves to operation S9.

[operation S4] If it is determined that the transmitted light upon initial start has an excessive level, a failure in a transmission system of the corresponding channel on the blade A side may be considered. The controller 25 transmits a stop signal to the signal generator 21.

[operation S5] The signal generator 21 transmits the stop signal to the band variable optical transmitter 22.

[operation S6] If the band variable optical transmitter 22 receives the stop signal, the band variable optical transmitter 22 performs E/O conversion to generate stop signal light and transmits the stop signal light to the band variable optical receiver 13 in the blade 10 through the midplane 30.

[operation S7] If the band variable optical receiver 13 receives the stop signal light, the band variable optical receiver 13 performs O/E conversion to generate an electrical stop signal and transmits it to the detector 14. If the detector 14 determines that the received signal is a stop signal (from the bit pattern of the received signal, for example), the detector 14 transmits the stop signal to the controller 15.

[operation S8] The controller 15 transmits a stop signal to the signal generator 11. The signal generator 11 stops the signal generation processing.

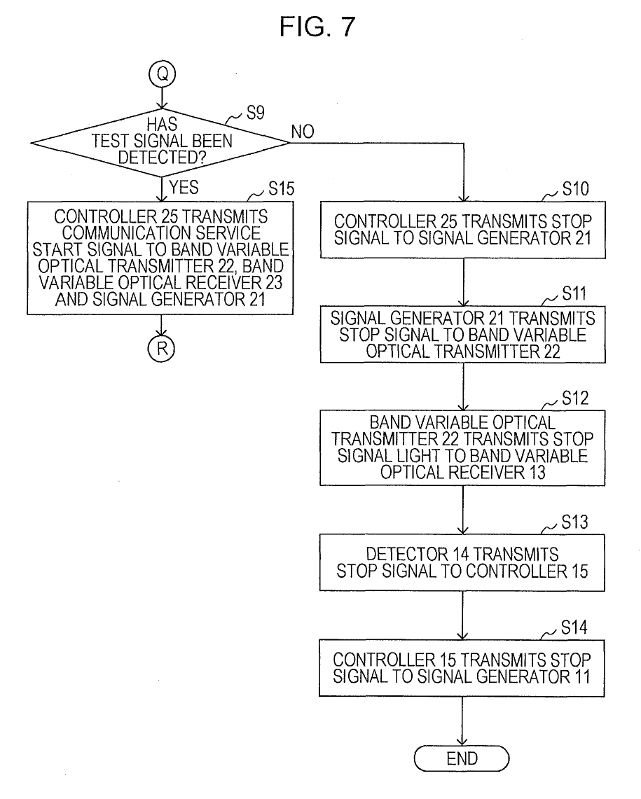

In this way, upon initial start, if excessive light beyond the eye-safety reference value is received, stop signal light is transmitted from the receiver side, and the emission of the excessive light is stopped. Thus, even a failure, for example, causes emission of light beyond the eye-safety reference value, the stop control works immediately, which may implement highly precise eye-safety. Operations will be continuously described below with reference to FIG. 7.

[operation S9] Subsequently to operation S3, if the detector 24 determines that the received signal has a low optical level, the detector 24 further determines whether the received signal is a test signal or not on the basis of the bit pattern of the received signal, for example. If the received signal is not a test signal, the processing moves to operation S10. If the received signal is a test signal, the processing moves to operation S15.

[operation S10] Upon initial start, if light which has a low optical level but is not test signal is transmitted, a failure of a transmission system of the corresponding channel on the blade A side may be suspected. The controller 25 transmits a stop signal to the signal generator 21.

[operation S11] The signal generator 21 transmits the stop signal to the band variable optical transmitter 22.

[operation S12] If the band variable optical transmitter 22 receives the stop signal, the band variable optical transmitter 22 performs E/O conversion to generate stop signal light and transmits the stop signal light to the band variable optical receiver 13 in the blade 10 through the midplane 30.

[operation S13] If the band variable optical receiver 13 receives the stop signal light, the band variable optical receiver 13 performs O/E conversion to generate an electrical stop signal and transmits it to the detector 14. If the detector 14 determines that the received signal is a stop signal (for example, on the basis of the bit pattern of the received signal), the detector 14 transmits the stop signal to the controller 15.

[operation S14] The controller 15 transmits the stop signal to the signal generator 11. The signal generator 11 stops the signal generation processing.

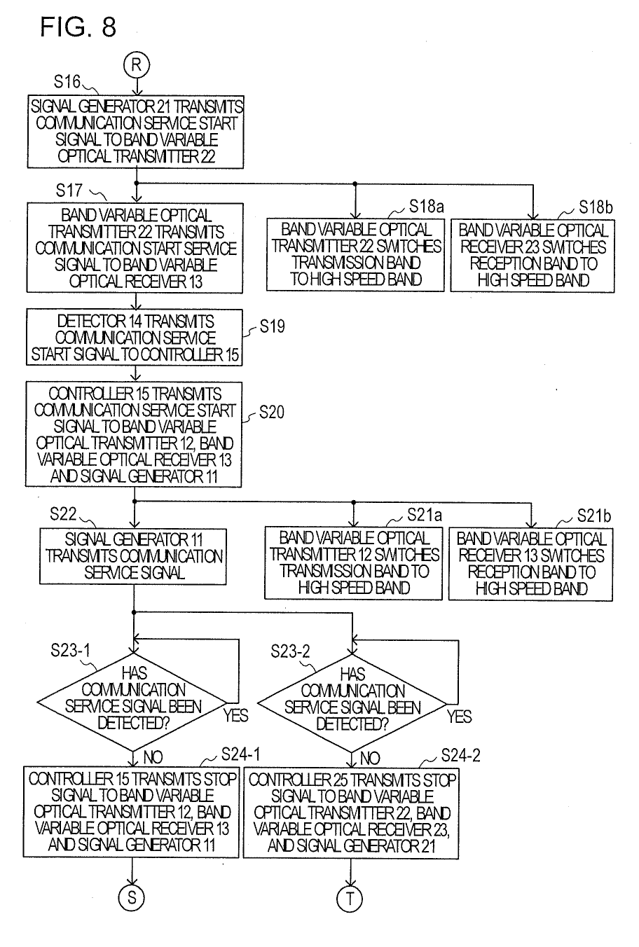

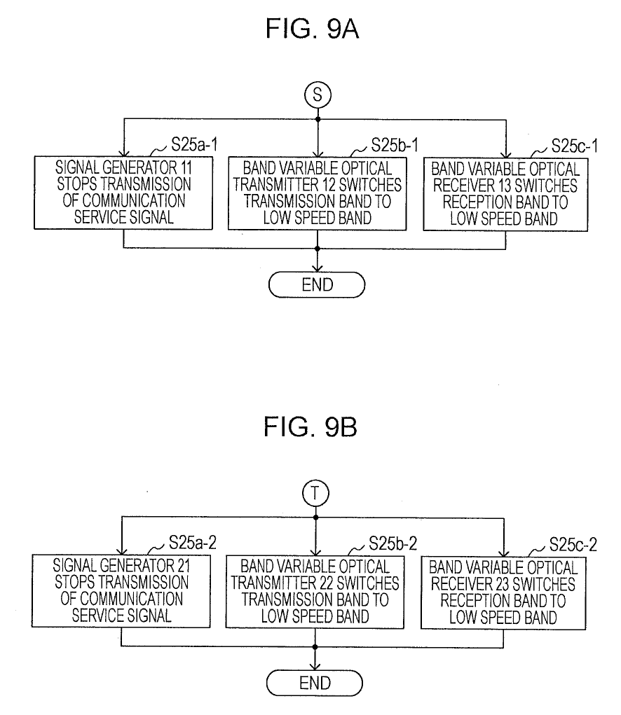

In this way, upon initial start, if light which has a low optical level but is not test signal light is received, the stop signal light is transmitted from the receiver side, and the emission of the light is stopped. Thus, even when a failure, for example, causes the emission of leak light, the stop control works immediately, which may improve the reliability of the system. Operation S15, FIG. 8 and FIGS. 9A and 9B will be described below.

[operation S15] If the controller 25 receives a test signal, the controller 25 transmits a communication service start signal to the signal generator 21, band variable optical transmitter 22 and band variable optical receiver 23. The communication service start signal is for notifying the start of the use of a communication service.

[operation S16] The signal generator 21 transmits to the band variable optical transmitter 22 a communication service start signal for notifying the start of the use of the communication service to the blade A side.

[operation S17] The band variable optical transmitter 22 performs E/O conversion on the communication service start signal to generate communication service start signal light and transmits it to the band variable optical receiver 13 in the blade 10 through the midplane 30.

[operation S18a] The band variable optical transmitter 22 switches the transmission band to a high-speed band for a normal operation.

[operation S18b] The band variable optical receiver 23 switches the reception band to a high-speed band for a normal operation.

[operation S19] If the band variable optical receiver 13 receives the communication service start signal light, the band variable optical receiver 13 performs O/E conversion to generate an electrical communication service start signal and transmits it to the detector 14. If the detector 14 determines that the received signal is the communication service start signal (for example, on the basis of the bit pattern of the received signal, the detector 14 transmits the communication service start signal to the controller 15.

[operation S20] If the controller 15 receives the communication service start signal, the controller 15 transmits to the signal generator 11, band variable optical transmitter 12 and band variable optical receiver 13 the communication service start signal for notifying the start of the use of the communication service.

[operation S21a] The band variable optical transmitter 12 switches the transmission band to a high-speed band for a normal operation.

[operation S21b] The band variable optical receiver 13 switches the reception band to a high-speed band for a normal operation.

[operation S22] The signal generator 11 starts transmitting a communication service signal.

[operation S23-1] The detector 14 determines whether the signal transmitted from the signal generator 11 is a communication service signal or not. If not, the processing moves to operation S24-1.

[operation S24-1] The controller 15 transmits a stop signal for the communication service to the band variable optical transmitter 12, band variable optical receiver 13 and signal generator 11.

[operation S25a-1] The signal generator 11 stops the transmission of the communication service signal.

[operation S25b-1] The band variable optical transmitter 12 switches the transmission band to a low-speed band.

[operation S25c-1] The band variable optical receiver 13 switches the reception band to a low-speed band.

[operation S23-2] The detector 24 determines whether the signal transmitted from the signal generator 21 is a communication service signal or not. If not, the processing moves to operation S24-2.

[operation S24-2] The controller 25 transmits the stop signal for the communication service to the band variable optical transmitter 22, band variable optical receiver 23 and signal generator 21.

[operation S25a-2] The signal generator 21 stops the transmission of the communication service signal.

[operation S25b-2] The band variable optical transmitter 22 switches the transmission band to a low-speed band.

[operation S25c-2] The band variable optical receiver 23 switches the reception band to a low-speed band.

When the test signal light is transmitted for the initial use, the test signal light has a low optical level not beyond the eye-safety reference value. When the light at a low optical level is transmitted by keeping the used band for a normal operation, the possibility of the misrecognition of the code by the receiver side may increase. In order to solve the problem, it is configured that test signal light is transmitted by not only setting it to a low optical level not beyond the eye-safety reference value but also switching the transmission band and reception band to a lower speed band than the operational high-speed band. This allows the use of the test signal light for accurately identifying the connection state of the other transmission party (destination apparatus) and may provide eye-safety.

When test signal light is to be transmitted from the blade 10 to the blade 20, the test signal light is transmitted to all channels to perform parallel optical transmission. The signal light is then transmitted to the channels returning response signal, and a communication service is implemented through the channels. Thus, the communication service may be provided by excluding a failed channel which is not usable if any, and the operability may be improved without abort of the communication service.

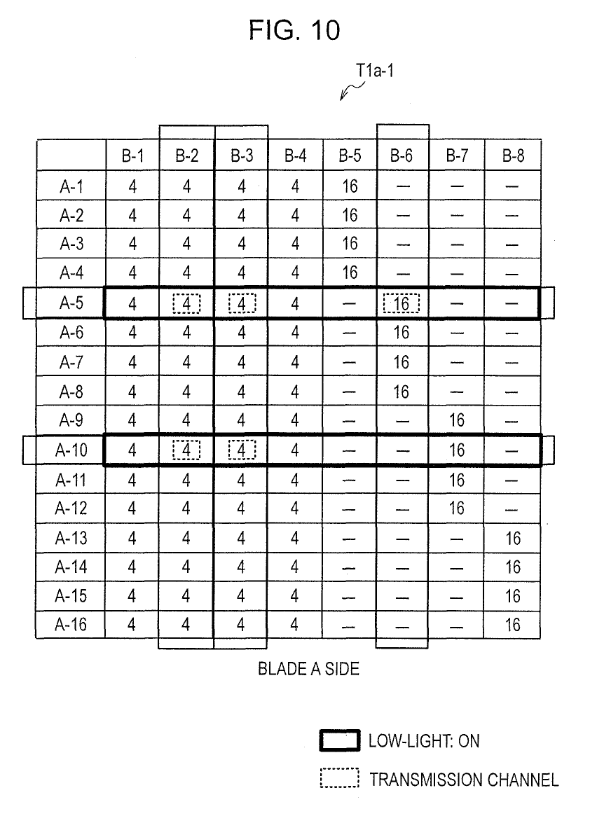

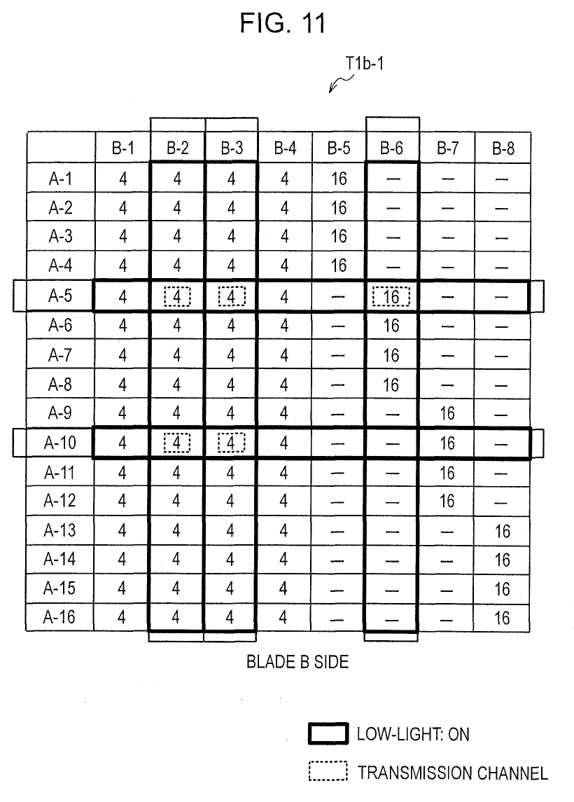

FIG. 10 and FIG. 11 illustrate management tables. FIG. 10 illustrates a management table T1a-1 from the viewpoint of the blade A side. FIG. 11 illustrates a management table T1b-1 from the viewpoint of the blade B side. In the blade server 1a, test signal light at a low light level flows between blades in order to check the other transmission party (destination apparatus) upon initial start.

Thus, referring to FIG. 10, for example, when the test signal light is transmitted from the blade A-5, the light leaking from the blades B-1, B-4, B-5, B-7, and B-8 which are not mounted of the blade B is low optical level (optical power) not beyond the eye-safety reference, which does not pose risk to the human body.

In the same manner, referring to FIG. 11, for example, when the test signal light is transmitted from the blade B-2, the light leaking from the blades A-1 to A-4, A-6 to A-9, and A-11 to A-16 which are not mounted of the blade A is low optical level (optical power) not beyond the eye-safety reference, which does not pose risk to the human body.

### Second Embodiment

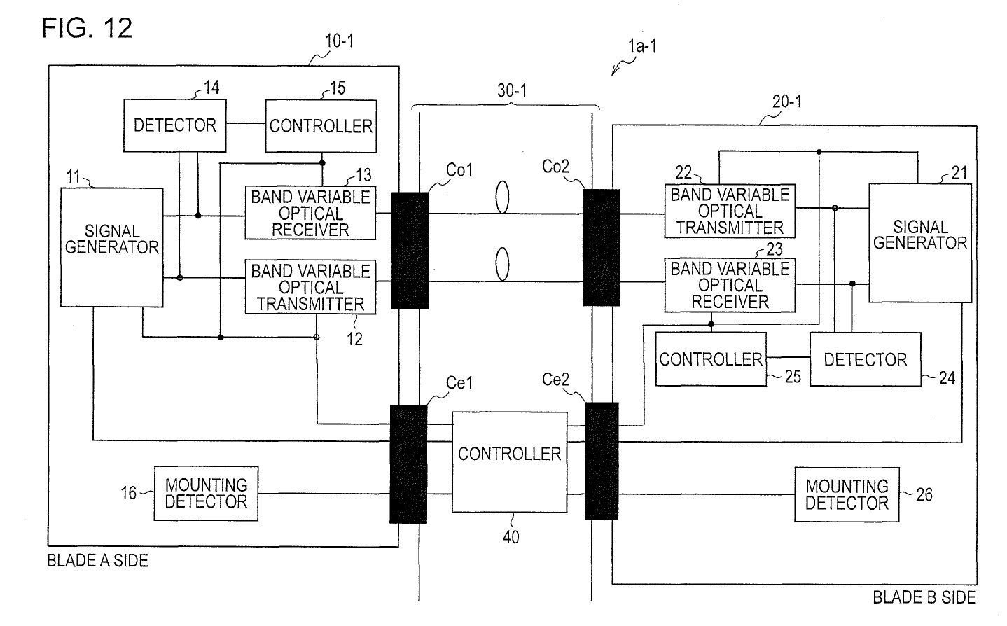

FIG. 12 illustrates a configuration example of a blade server. A blade server 1a-1 includes a blade 10-1, a blade 20-1, a midplane 30-1 and a controller 40. Like numbers refer to like components to those in the blade server is in FIG. 5, and the description will be omitted.

The blade 10-1 is connected to a predetermined connection part of a midplane 30-1 through an optical connector Co 1 and an electrical connector Ce 1. The blade 20-1 is connected to a predetermined connection part of the midplane 30-1 through an optical connector Co 2 and an electrical connector Ce 2.

In this case, the blade 10-1 is connected to the controller 40 through electrical wiring on the midplane 30-1 via the electrical connector Ce 1. The blade 20-1 is connected to the controller 40 through electrical wiring on the midplane 30-1 via the electrical connector Ce 2. The blade 10-1 and blade 20-1 performs mutual optical transmission through optical fiber provided by optical interconnect within the midplane 30-1.

The blade 10-1 includes a signal generator 11, a band variable optical transmitter 12, a band variable optical receiver 13, a detector 14, a controller 15 and a mounting detector 16. The blade 20-1 includes a signal generator 21, a band variable optical transmitter 22, a band variable optical receiver 23, a detector 24, a controller 25 and a mounting detector 26.

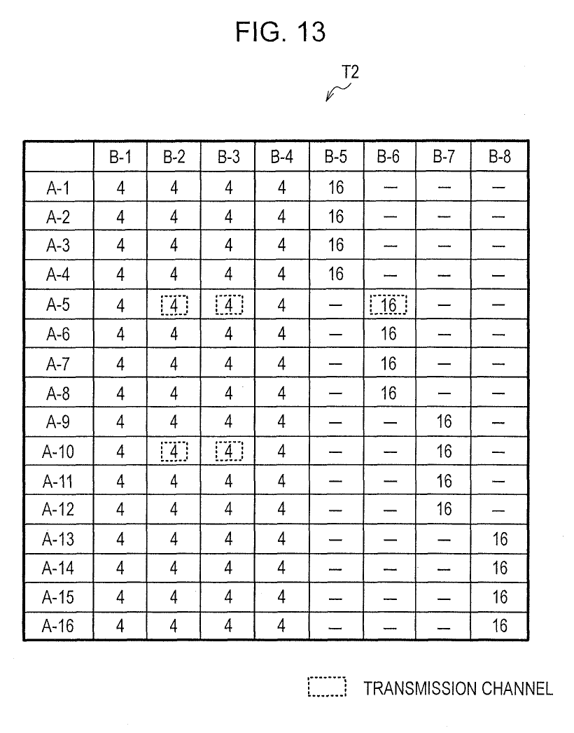

The controller 40 communicates with the mounting detector 16 within the blade 10-1 through electrical interface and communicates with the mounting detector 26 within the blade 20-1 through electrical interface. The controller 40 internally includes a management table (which will be described below with reference to FIG. 13) for managing transmission parties (source apparatus and destination apparatus) between a plurality of blades.

The controller 40 transmits to mutually communicating blades on the management table (such as blades 10-1 and 20-1 here) a mounting check signal for determining whether the blades 10-1 and 20-1 are mounted on the midplane 30-1 or not.

If the blade 10-1 responds to the mounting check signal, the controller 40 transmits state notification that the blade 10-1 is mounted to the blade 20-1. If the blade 20-1 responds to the mounting check signal, the controller 40 transmits state notification that the blade 20-1 is mounted to the blade 10-1.

If the mounting detector 16 receives the mounting check signal transmitted from the controller 40, the mounting detector 16 returns a mounting response signal indicating that it (blade 10-1) is mounted, to the controller 40. If the mounting detector 26 receives the mounting check signal transmitted from the controller 40, the mounting detector 26 returns a mounting response signal indicating that it (blade 20-1) is mounted, to the controller 40. Both of the check signal and mounting response signal are electrical signals.

FIG. 13 illustrates an example of the management table provided in the controller 40. A management table T2 illustrates transmission management states between blades A-1 to A-16 and blades B-1 to B-8. For example, the data stored in the management table T2 indicates that the blade A-5 communicates with the blade B-1 to blade B-4 and blade B-6.

The blade A-5 performs 4-channel parallel optical transmission to the blade B-1 to blade B-4 and 16-channel parallel optical transmission to the blade B-6.

An operation by the controller 40 on the blade A-5, blade B-1 to blade B-4 and blade B-6 will be described below. The controller 40 transmits a mounting check signal to the blade A-5 and transmits a mounting check signal to the blade B-1 to blade B-4 and blade B-6. In this case, for example, if two of blade A-5 and blade B-1 are mounted, the blade A-5 and blade B-1 return mounting response signals to the controller 40.

The controller 40 receives the mounting response signal transmitted from the blade A-5 and the mounting response signal transmitted from the blade B-1. As a result, the controller 40 performs state notification to the blade A-5 of that the blade B-1 is being mounted and state notification to the blade B-1 of that the blade A-5 is being mounted.

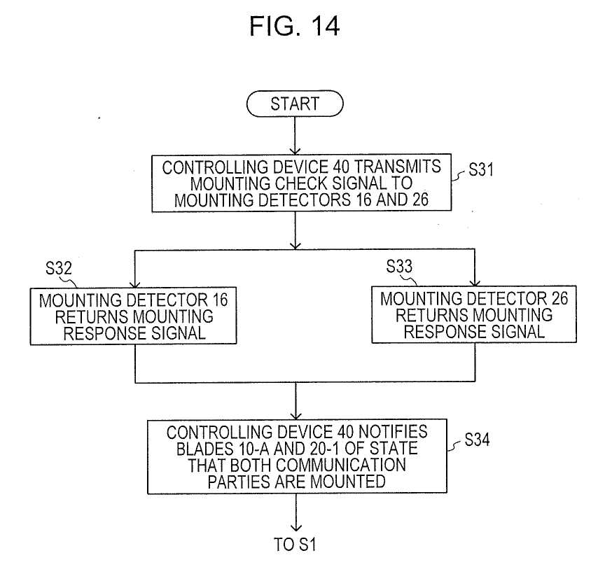

FIG. 14 is a flowchart illustrating an operation for identifying the mounting state of the other transmission party.

[operation S31] Upon initial start, the controller 40 transmits a mounting check signal to the mounting detectors 16 and 26.

[operation S32] If the mounting detector 16 within the blade 10-1 receives the mounting check signal transmitted from the controller 40, the mounting detector 16 returns a mounting response signal indicating that it is being inserted to the midplane 30-1 to the controller 40.

[operation S33] If the mounting detector 26 within the blade 20-1 receives a mounting check signal transmitted from the controller 40, the mounting detector 26 returns a mounting response signal indicating that it is being inserted to the midplane 30-1 to the controller 40.

[operation S34] The controller 40 transmits a state notification of that the blade 20-1 which is the other party is being mounted to the signal generator 11 within the blade 10-1. The controller 40 transmits a state notification of that the blade 10-1 which is the other transmission party is being mounted to the signal generator 21 within the blade 20-1.

After that, the processing moves to operation S1 in FIG. 6, and the aforementioned operation flow is performed. However, the test signal light is transmitted in operation S2 only to a blade mounted on the midplane 30-1, which is notified from the controller 40.

In the blade server 1a (FIG. 5), in order to check optical connection of blades to a midplane with test signal light upon initial start, the test signal light having an optical level (optical power) set to be not beyond the eye-safety reference value to all destinations of the other transmission party, independent of the mounting/unmounting of the other transmission party.

Blades perform parallel optical transmission. Thus, when one channel fails, there is a possibility that light at an optical level beyond the eye-safety reference value may be transmitted in the channel though the light is set to have a low optical level.

On the other hand, in the blade server 1a-1 of the present embodiment, transmission with an electrical signal is performed upon initial start to check whether the other transmission parties are being mounted or not and test signal light is only transmitted to the mounted transmission parties to check the optical connection state.

This allows flow of excessive light output by a specific failing channel to a blade optically connected to the midplane. Thus, light at a higher level than the eye-safety reference value does not leak from unmounted parts of the midplane or a connection defective, and eye-safety may be securely implemented.

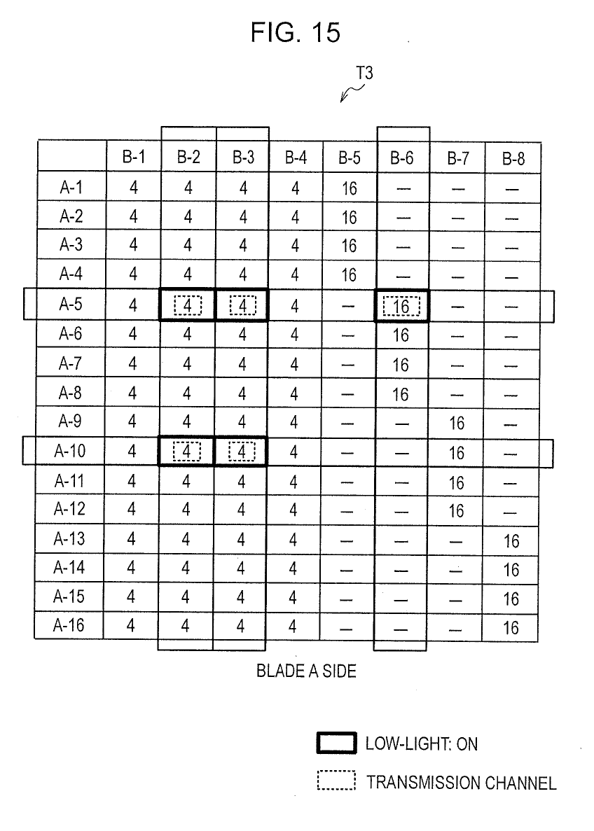

FIG. 15 illustrates a management table. FIG. 15 illustrates a management table T3 illustrating connections between blades in the blade server 1a-1. The blades A-5 and A-10 is mounted on the midplane 30-1 on the blade A side, and the blades B-2, B-3, and B-6 are mounted on the midplane 30-1 on the blade B side. At the parts within a thick solid frame, test signal light at a low light level flows.

In the blade server 1a-1, the mounting check is performed with the electrical signal as described above, and the test signal light at a low light level is only provided to mounted blades. Thus, like the parts within the thick solid frames, the blade A-5 transmits the test signal light to the blades B-2, B-3, and B-6, and the blade A-10 transmits the test signal light to the blades B-2 and B-3.

For the reason above, the test signal light is not transmitted to the unmounted destination blades (destination apparatuses). For example, because the blade A-5 does not transmit the test signal light to the unmounted blades B-1 and B-4, the test signal light from the blade A-5 does not leak from the connection parts for the blade B-1 and B-4.

### Third Embodiment

In the third embodiment, the functions of the controller 40 are included in a blade. The fundamental operations are the same as those of the blade server 1a-1 of the second embodiment.

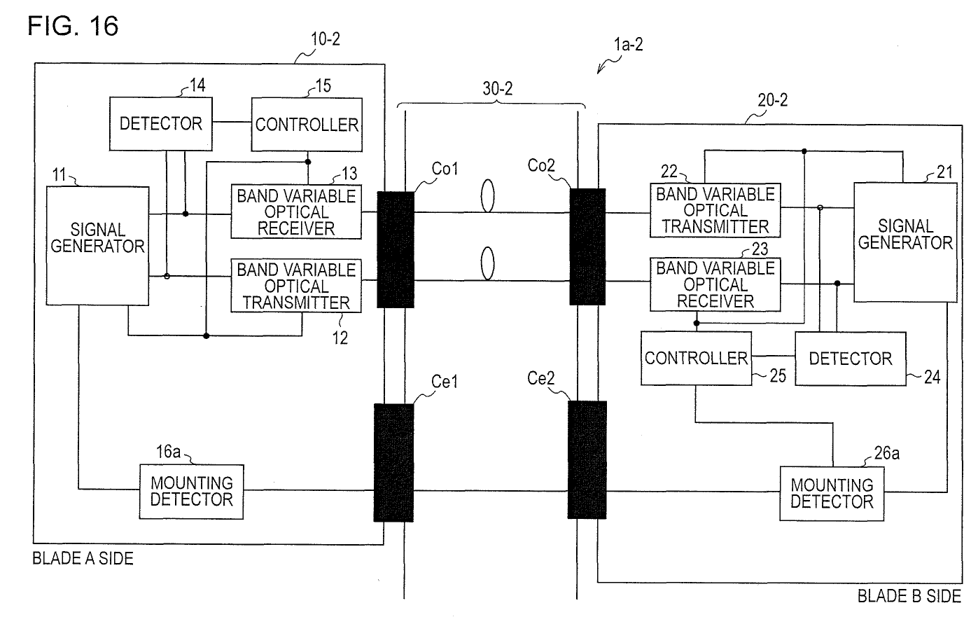

FIG. 16 illustrates a configuration example of a blade server. Like numbers refer to like components to those in the blade server 1a, and the description will be omitted.

A blade server 1a-2 includes a blade 10-2, a blade 20-2 and a midplane 30-2. The blade 10-2 connects to a predetermined connection part on a midplane 30-2 through an optical connector Co 1 and an electrical connector Ce 1. The blade 20-2 connects to a predetermined connection part on the midplane 30-2 through an optical connector Co 2 and an electrical connector Ce 2.

In this case, a mounting detector 16a within the blade 10-2 and the mounting detector 26a within the blade 20-2 are connected through electrical wiring within the midplane 30-2. The blade 10-2 and blade 20-2 performs mutual optical transmission through optical fiber provided by optical interconnect within the midplane 30-2.

The blade 10-2 includes a signal generator 11, a band variable optical transmitter 12, a band variable optical receiver 13, a detector 14, a controller 15 and a mounting detector 16a. The blade 20-2 includes a signal generator 21, a band variable optical transmitter 22, a band variable optical receiver 23, a detector 24, a controller 25 and a mounting detector 26a.

Here, the mounting detectors 16a and 26a have the aforementioned functions of the controller 40. The mounting detector 16a and the mounting detector 26a communicate by electrical interface. The mounting detector 16a detects a blade to communicate, which is on a management table owned by the mounting detector 16a and transmits to the blade (such as the blade 20-2 here) a mounting check signal for determining whether it is being mounted to the midplane 30-2 or not.

If the mounting detector 26a in the blade 20-2 returns a mounting response signal to the mounting check signal, a state notification of that the blade 20-2 is being mounted is transmitted to the signal generator 11.

In the same manner, the mounting detector 26a detects a blade to communicate, which is on a management table owned by the mounting detector 26a and transmits to the blade (such as the blade 10-2 here) a mounting check signal for determining whether it is being mounted to the midplane 30-2 or not.

If the mounting detector 16a in the blade 10-2 returns a mounting response signal to the mounting check signal, a state notification of that the blade 10-2 is being mounted is transmitted to the signal generator 21.

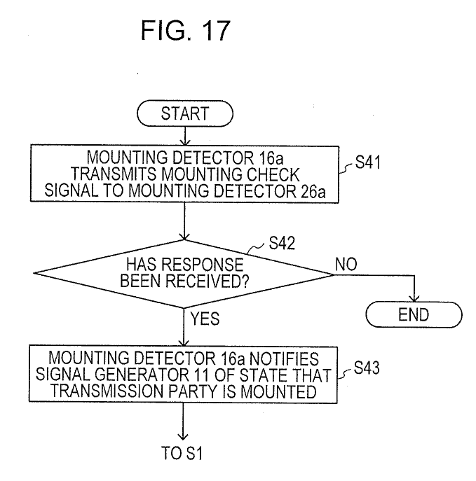

FIG. 17 is a flowchart illustrating an operation for identifying the mounting state of the other transmission party (destination apparatuses).

[operation S41] The mounting detector 16a transmits a mounting check signal to the mounting detector 26a.

[operation S42] The mounting detector 16a determines whether the mounting detector 26a returns a mounting response signal or not. If not, the processing ends. If so, the processing moves to operation S43.

[operation S43] The mounting detector 16a transmits a state notification of that the blade 20-2 is being mounted to the signal generator 11.

After that, the processing moves to operation S1 in FIG. 6, and the operation is performed. However, the test signal light is transmitted in operation S2 only to a blade mounted on the midplane 30-2.

According to the configuration of this embodiment, the excessive light output by a specific failing channel flows to a blade optically connected to the midplane. Thus, light at a high level does not leak from unmounted parts of the midplane or a connection defective, and eye-safety may be securely implemented. The size of circuit may be reduced, compared with the second embodiment.

### Other

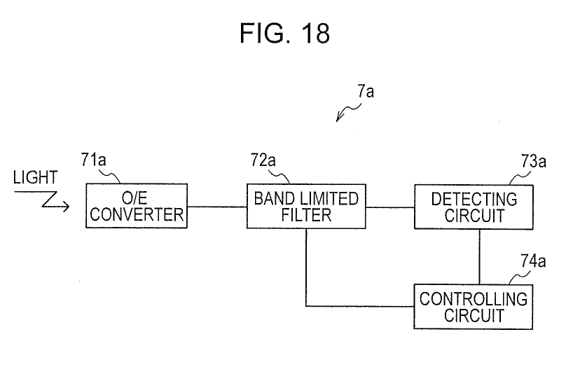

Next, a configuration example of a band variable optical receiver will be described. FIG. 18 illustrates a configuration example of a band variable optical receiver. A band variable optical receiver 7a includes an O/E converter 71a, a band limited filter 72a, a detecting circuit 73a and a controlling circuit 74a.

The O/E converter 71a converts received optical signal (light) to an electrical signal. The band limited filter 72a performs band limited filtering on the basis of a control signal output from the controlling circuit 74a. The detecting circuit 73a detects the filtering result and transmits it to the controlling circuit 74a. The controlling circuit 74a generates a control signal such that the detected filtering result may have a predetermined value and transmits it to the band limited filter 72a.

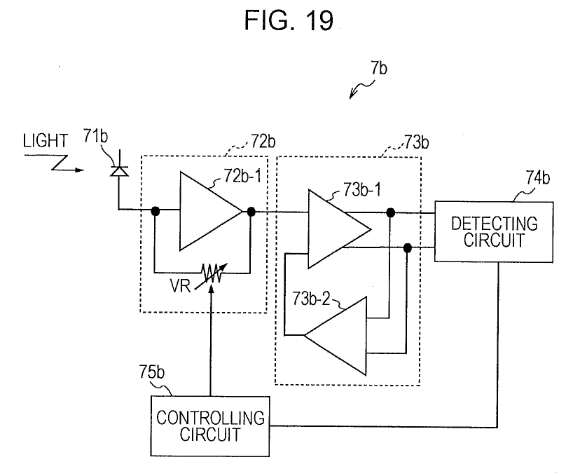

FIG. 19 illustrates a configuration example of a band variable optical receiver. A band variable optical receiver 7b includes a light receiving element 71b, a preamplifier 72b, a limiter amplifier 73b, a detecting circuit 74b and a controlling circuit 75b. The preamplifier 72b includes an amplifier 72b-1 and a variable resistor VR. The limiter amplifier 73b includes amplifiers 73b-1 and 73b-2.

Describing the connection relationship between the components, a cathode of the light receiving element 71b connects to an input end of the amplifier 72b-1 and one end of the variable resistor VR. The output terminal of the amplifier 72b-1 connects to the other end of the variable resistor VR and one input end of the amplifier 73b-1. The other input end of the amplifier 73b-1 connects to an output terminal of the amplifier 73b-2.

One output terminal of the amplifier 73b-1 connects to one input end of the amplifier 73b-2 and one input end of the detecting circuit 74b. The other output terminal of the amplifier 73b-1 connects to the other input end of the amplifier 73b-2 and the other input end of the detecting circuit 74b.

The light receiving element 71b converts received light (optical signal) to an electrical signal. The preamplifier 72b determines the value of the variable resistor VR on the basis of the control signal output from the controlling circuit 75b and performs band limited filtering.

The limiter amplifier 73b limits the output amplitude (output level) of the filtered signal, converts it to a digital signal and outputs it to the detecting circuit 74b. The detecting circuit 74b detects the filtering result and transmits it to the controlling circuit 75b. The controlling circuit 75b generates a control signal such that the detected filtering result may have a predetermined value and transmits it to the preamplifier 72b.

Having illustrates embodiments, the configurations of the components according to the aforementioned embodiments may be replaced by others having the similar functions. Another arbitrary component and/or operation may be added.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An optical transmission system comprising:
a first optical transmission apparatus configured to have a first transmission mode in which a first signal is transmitted at a first optical level, and a second transmission mode in which a second signal is transmitted at a second optical level after an operation in the first transmission mode, the first optical level being lower than the second optical level; and
a second optical transmission apparatus configured to have a third transmission mode in which a response signal to the first signal is transmitted at the first optical level to the first optical transmission apparatus, and a fourth transmission mode in which a response signal to the second signal is transmitted at the second optical level to the first optical transmission apparatus after an operation in the third transmission mode.

2. The optical transmission system according to claim 1, wherein:
each of the first signal and the response signal to the first signal has a first transmission band; and
each of the second signal and the response signal to the second signal has a second transmission band higher than the first transmission band.

3. The optical transmission system according to claim 1, wherein the first signal is transmitted to one or more channels of the second optical transmission apparatus in the first transmission mode, and the first optical transmission apparatus transmits the second signal, in the second transmission mode, to one or more channels of the second optical transmission apparatus that the first optical transmission apparatus receives the response signal to the first signal.

4. The optical transmission system according to claim 1, wherein the second optical transmission apparatus transmits, to the first optical transmission apparatus, a request signal to stop transmission of the first signal when the second optical transmission apparatus receives the first signal having a predetermined optical level.

5. The optical transmission system according to claim 1, wherein the first optical transmission apparatus transmits the first signal to the second optical transmission apparatus in spite of un-mounting of the second optical transmission apparatus in the system.

6. An optical transmission system comprising:
a controller configured to have a management table in which data indicating a relation of a source apparatus and a destination apparatus is stored, detect whether the source apparatus and the destination apparatus are coupled, and notify the source apparatus and the destination apparatus of a detected connection state of the source apparatus and the destination apparatus;
a first optical transmission apparatus configured to have a first transmission mode in which a first signal is transmitted at a first optical level between the source apparatus and the destination apparatus which are coupled, and a second transmission mode in which a second signal is transmitted at a second optical level after an operation in the first transmission mode, the first optical level being lower than the second optical level; and
a second optical transmission apparatus configured to have a third transmission mode in which a response signal to the first signal is transmitted at the first optical level to the first optical transmission apparatus, and a fourth transmission mode in which a response signal to the second signal is transmitted at the second optical level to the first optical transmission apparatus after an operation in the third transmission mode,
wherein the first optical transmission apparatus is one of a plurality of source apparatuses and the second optical transmission apparatus is one of a plurality of destination apparatuses.

7. The optical transmission system according to claim 6, wherein:
each of the first signal and the response signal to the first signal has a first transmission band; and
each of the second signal and the response signal to the second signal has a second transmission band higher than the first transmission band.

8. The optical transmission system according to claim 6, wherein the first signal is transmitted to one or more channels of the second optical transmission apparatus in the first transmission mode, and the first optical transmission apparatus transmits the second signal, in the second transmission mode, to one or more channels of the second optical transmission apparatus that the first optical transmission apparatus receives the response signal to the first signal.

9. The optical transmission system according to claim 6, wherein the second optical transmission apparatus transmits, to the first optical transmission apparatus, a request signal to stop transmission of the first signal when the second optical transmission apparatus receives the first signal having a predetermined optical level.

10. An optical transmission apparatus comprising:
a transmitter configured to have a first transmission mode in which a first signal is transmitted at a first optical level, and a second transmission mode in which a second signal is transmitted at a second optical level after an operation in the first transmission mode, the first optical level being lower than the second optical level; and
a receiver configured to have a third transmission mode in which a response signal to the first signal is received at the first optical level, and a fourth transmission mode in which a response signal to the second signal is received at the second optical level after an operation in the third transmission mode.
